(19) United States
(12) Patent Application Publication
(10) Pub. No.: US 2006/0229925 A1
(43) Pub. Date: Oct. 12, 2006

(54) Automatic discovery and maintenance of business processes in web services and enterprise development environments

(75) Inventors: Nanchariah R. Chalasani, Raleigh, NC (US); Mandar U. Jog, Raleigh, NC (US); Neeraj R. Joshi, Morrisville, NC (US); Balan Subramanian, Morrisville, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/102,023

(22) Filed: Apr. 8, 2005

(51) Int. Cl. G05B 19/418

(52) U.S. Cl. 705/8

(57) ABSTRACT

A method, an apparatus, and computer instructions are provided for automatic discovery and maintenance of business processes in Web services and enterprise development environments. A set of agents are deployed to a set of enterprise containers to collect user function calls and report events to a central business workflow language generator. An event handler collects the events reported and an event grouper groups the events into a single workflow activity. An event correlation engine correlates activities to business workflow language constructions by using a temporal condition handler and a collection counting handler. The temporal condition handler maps activities that are in sequence, in parallel, and are repetitive. The collection counting handler counts the number of times an event is handled. Events and Rules for these events are written on the system based on a variety of business constructs that are particular to given business process definition language. A business workflow language generator then generates a business workflow and a workflow presents the business workflow in a user interface.

### BACKGROUND OF THE INVENTION

The present invention relates to a data processing system, and more particularly, to business processes in Web services and enterprise development environment.

Most enterprise infrastructures, such as Java™ 2 Platform, Enterprise Edition (J2EE™) or Microsoft .NET™, provide services to users, group a service as a single unit with little reuse. Java and J2EE are trademarks of Sun Microsystems, Inc. in the United States, other countries or both while Microsoft .NET is a trademark of Microsoft Corporation in the United States, other countries or both. These infrastructures lack understand of workflows within the enterprise. This lack of understanding affects the enterprise in terms of its information technology systems, work requirements, and integration with other business partners when better services are required quickly. Current infrastructures often replicate similar services in order to achieve reuse.

With existing enterprise infrastructures, there is no persistence of transactions to a persisted storage, such that when a service failure occurs with a business partner the transactions may be recovered. Even if the transactions are persisted, current enterprise infrastructures fail to distinguish between transactions that are interruptible and non-interruptible. Interruptible transactions are business transactions that are short running and may not require persistence, while non-interruptible transactions are business transactions that are long running and may require persistence. Most of the existing infrastructures fail to classify such type of transactions based upon enterprise feasibility and business requirements. Even if these infrastructures support non-interruptible transactions, these infrastructures are manipulated and customized for the specific environment.

In addition, current enterprise infrastructures that provide service-oriented architectures and business workflow modeling often use proprietary or non-standard workflow formats, legacy applications, specific workflow modeling tools, and perform no correlation between the business workflow activities and the business workflow languages. Currently, a user has to manually translate incoming events or messages into a business workflow event based on the business workflow language.

### BRIEF SUMMARY OF THE INVENTION

The present invention is directed in part to automatic discovery and maintenance of business processes in web services and enterprise development environments. The mechanism of the present invention deploys a set of agents to a set of enterprise containers, and provides an event grouper that groups events into a single business activity responsive to detecting events reported by an agent in the set of agents. The present invention also provides an event correlation engine that correlates activities into business workflow language constructs based on a set of rules in a rules engine.

The present invention then provides a business workflow language generator that generates a business workflow based on the business workflow language constructs. Finally, the present invention provides a workflow editor that presents the business workflow in a user interface to the user.

### BRIEF DESCRIPTION OF THE SEVERAL VIEWS OF THE DRAWINGS

FIG. 1 is a pictorial representation of a network of data processing systems that is depicted in accordance with an aspect of the present invention;

FIG. 2 is a block diagram of a data processing system that may be implemented as a server that is depicted in accordance with an aspect of the present invention;

FIG. 3 is a block diagram illustrating a data processing system that is depicted in accordance with an illustrative embodiment of the present invention;

FIG. 4 is a diagram illustrating existing infrastructures;

FIG. 5 is a diagram illustrating and interaction between agents deployed in the infrastructures and a business workflow language generator in accordance with an illustrative embodiment of the present invention;

FIG. 6 is a diagram illustrating an exemplary Web service deployment descriptor in accordance with an illustrative embodiment of the present invention;

FIG. 7 is a diagram illustrating an exemplary business workflow language generator in accordance with an illustrative embodiment of the present invention;

FIG. 8 is a diagram illustrating exemplary infrastructures with the business workflow language generator in accordance with an illustrative embodiment of the present invention; and

FIG. 9 is a flowchart of an exemplary process for automatic discovery and maintenance of business processes in Web services and enterprise development environments in accordance with an illustrative embodiment of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

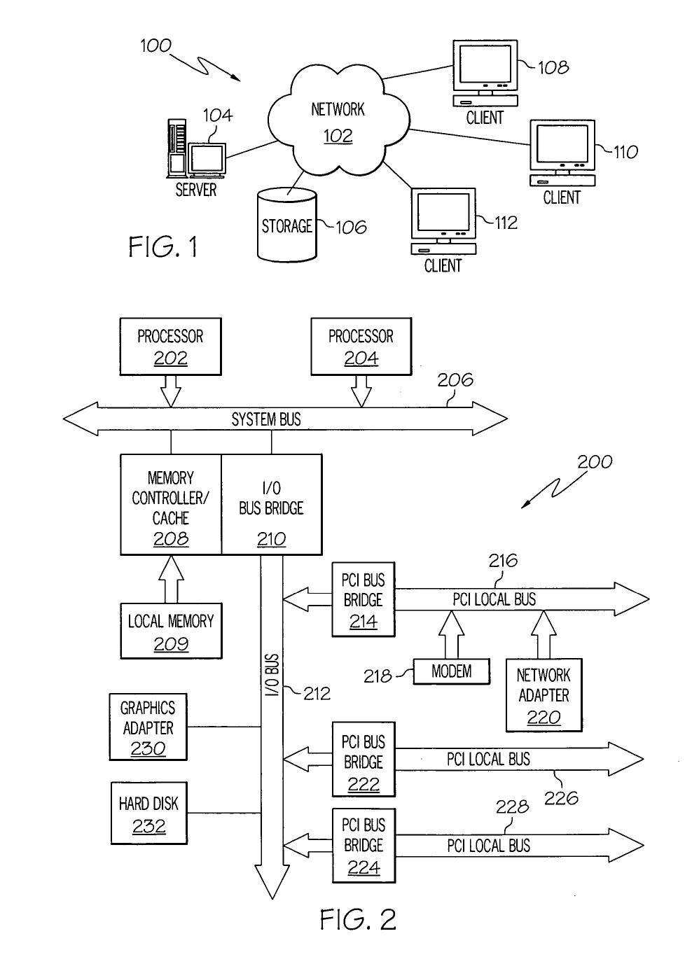

Referring to FIG. 2, a block diagram of a data processing system that may be implemented as a server, such as server 104 in FIG. 1, is depicted in accordance with an aspect of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM® eServer™ pSeries® computer system, a product of International Business Machines Corporation in Armonk, N.Y., running the Advanced Interactive Executive (AIX®) operating system or LINUX operating system (IBM, eServer, pseries and AIX are trademarks of International Business Machines Corporation in the United States, other countries, or both, while Linux is a trademark of Linus Torvalds in the United States, or other countries, or both).

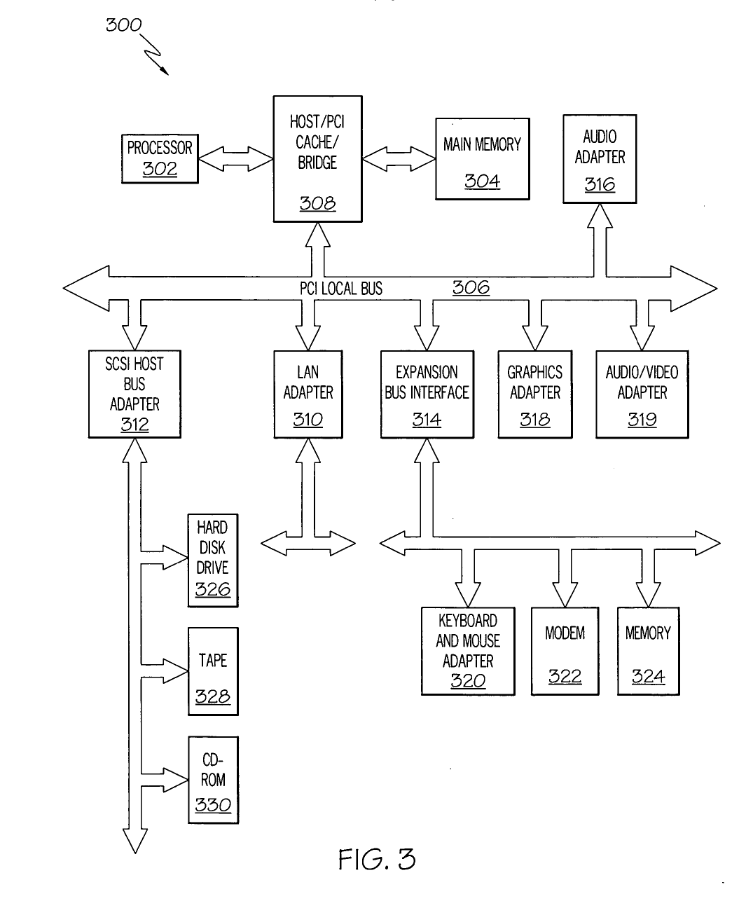

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Microsoft® Windows® XP (Microsoft and Windows are trademarks of Microsoft Corporation in the United States, other countries, or both). An object-oriented programming system, such as Java, may run in conjunction with the operating system and provide calls to the operating system from Java programs or applications executing on data processing system 300. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, an apparatus, and computer instructions for automatic discovery and maintenance of business processes in Web services and enterprise development environments. The processes and mechanisms of the present invention may be implemented as part of an application executed by data processing systems, such as data processing system 200 in FIG. 2 and data processing system 300 in FIG. 3.

In an illustrative embodiment, the present invention first deploys agents to a variety of enterprise infrastructures in order to gather a list of user function calls over a period of time. The agents are deployed to provide correlation at each domain or enterprise infrastructure. In this way, a distributed set of workflows may be generated at each domain based on the message domains. Since agents are non-intrusive to the underlying domain or enterprise infrastructure, business workflow generation may be accomplished without changes to the existing infrastructures.

Upon gathering a list of user calls, the deployed agents generate events based on a business workflow language. Examples of a business workflow language include business process execution language (BPEL), business process modeling language (BPML), and business process specification schemas (BPSS). The agents in turn report the events to a business workflow generator provided by the present invention. The generator includes an event handler that accepts the events and groups them to a single workflow activity.

The event handler also collects the events from various deployed agents and correlates the events using an existing autonomic correlation technology that generates a sequence of events, parallel events, and repetitive events. In addition to agents and the event handler, the present invention also provides a business workflow language event correlation engine to correlate workflow activities into business workflow language constructs. The correlation is performed based on rules in a rules engine. These rules are written according to the business process definition language of interest and the events are mapped back into the constructs of the language. In one embodiment, the business workflow language event correlation engines are distributed at different domains to achieve scalability. Alternatively, the correlation engine may be centralized, such that transparent business workflows may be developed and used across multiple domains.

The event correlation engine includes a temporal condition handler, which handles temporal conditions of the events, and a collection counting handler, which collects the number of times a particular message or event is handled. Depending on the business workflow language, temporal conditions may arrange events differently. For example, in BPEL, existing system workflows and flow of information maybe mapped to business workflow language activities, such as Receive, Sequence, Flow, While, Pick, and Reply. As to collection counting, the number of times a particular message is handled may be counted to determine the While and Switch activities. Thus, with the temporal condition and collection counting handlers, the present invention discovers and composes business processes from low level work flows while mapping low level correlations to workflow language correlations. For example, a low level correlation can be a series of four events from three servers which map into a single event into the work flow language description. In BPEL, local level correlation can be occurrence of three low-level sequential events which results in one high level sequence mapping.

In one illustrative embodiment, in order to compose business processes from workflow activities, correlation rules have to be defined for the business workflow language. For example, in BPEL, a Sequence rule is defined when various services are called sequentially. A Flow rule is defined when different activities are invoked in parallel and executed randomly during application runtime. A Switch rule is defined to execute a service based on whether a condition of context of the message is met. A While rule is defined for repetition of a particular activity more than once, such that the type of message being invoked can be detected. A Wait is defined for a certain period of time, duration or a date. A Receive rule is defined when a message reaches an enterprise JavaBean™ software program or a Web service (JavaBean is a trademark of Sun Microsystems, Inc. in the United States, other countries or both).

Also, in BPEL, a Reply rule is defined when a corresponding reply exists for a function call that is made to an enterprise JavaBean software program or a Web service. An Invoke rule is defined when an enterprise JavaBean software program or a Web service calls a method asynchronously to place a message into a queue. A Pick rule is defined when a message is invoked after waiting for a certain period of time from outside the network. A Stop rule is defined when a fault message occurs inside an enterprise JavaBean software program or a Web service handler, which results in termination of the business workflow. A Compensation rule is defined when allows a user to call a compensation logic when a fault occurs. A Staff Activity rule is defined when a user is involved in a staff activity. A staff activity may be detected by a correlation pattern with various wait patterns and message formats.

Once the handlers of the business workflow language event correlation engine handle the events, a workflow editor is provided by the present invention to present to the user a business workflow that is generated by the business workflow language generator.

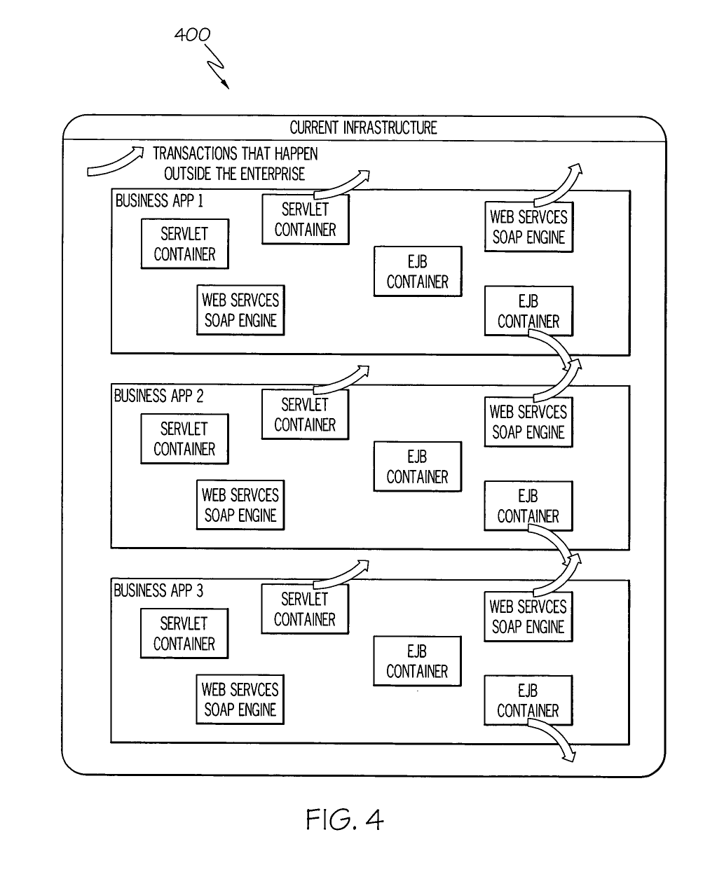

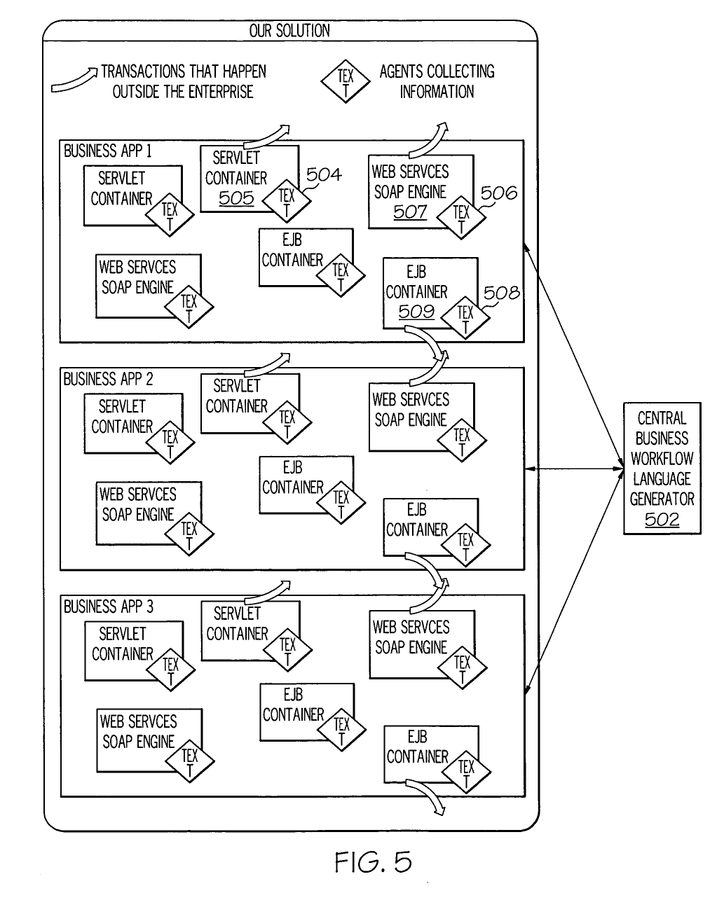

Turning now to FIG. 4, a diagram illustrating existing infrastructures is depicted. As shown in FIG. 4, in existing infrastructures 400, business applications may include containers that involve transactions outside of the enterprise. For example, in each of business application 1, business application 2, and business application 3, servlet containers, Web services SOAP engine containers, and EJB containers involve transactions outside of the enterprise.

While these transactions involve outside enterprises, each of these business applications use propriety or non-standard workflow formats that are not understood by the outside enterprises. In addition, each of these business applications may use its own workflow modeling tool to model the business workflow. Thus, it would be desirable to have a mechanism that can correlate the transactions into business workflows that can be understood by outside enterprises.

Turning now to FIG. 5, a diagram illustrating and interaction between agents deployed in the infrastructures and a business workflow language generator is depicted in accordance with an illustrative embodiment of the present invention. As shown in FIG. 5, business applications 1, 2, and 3 are similar to business applications 1, 2, and 3 in FIG. 4, except that agents are deployed in each of the containers in business applications 1, 2, and 3. Agents are classified into domains or enterprise infrastructure based on organization characteristics. For example, servlet agent 504 is deployed to servlet container 505. Web Services agent 506 is deployed to Web services SOAP engine 507. EJB filter agent 508 deployed to EJB container 509.

Once the agents collect the events, the agents report events to central business workflow language generator 502. Central business workflow language generator 502 report events in a manner that is easily understandable by the user. In cases where there are too many events for a particular filter, central business workflow language generator 502 has the capability to ignore certain types of events.

In this example, servlet agent 504 may be implemented using a component called filter, which is a type of component according to the Java Servlet Specification version 2.3 available from Sun Microsystems, Inc. A filter dynamically intercepts requests and responses to transform or use information contained in the requests or responses. Filters may be attached to any type of servlets or Java server pages (JSP). The present invention may use filters to get a URL request and the servlet name that was invoked and forward the information to central business workflow language generator 502.

Filters are preferred for a variety of reasons. First, filters can encapsulate recurring tasks in reusable units. In this way, developers may modularize their code using these reusable units. Filters are also more manageable and easy to debug. Second, filters may be used to transform the response from a servlet or a JSP. To form filters, filter mappings are ordered in the order that filter mappings appear in the Web application deployment descriptor. Thus, the filter is placed at the beginning of the Web application deployment descriptor, such that it will be called at the beginning of the servlet patterns.

Since Web services handlers, such as a JAX-RPC handler, intercept SOAP messages at various times during a Web service invocation, a Web service handler may be defined for the server side to intercept messages and define a chain of handler messages that can be invoked prior to the Web service. In this example, Web services agent 506 may be implemented as a JAX-RPC handler programmed to monitor individual request and response messages and report the messages to central business workflow language generator 502. The handler may be used as a transporter for information, including port type, start timing, and invoked operation calls. Web services agent 506 detects when the operation ends and the business process activities that start after ending of the operation.

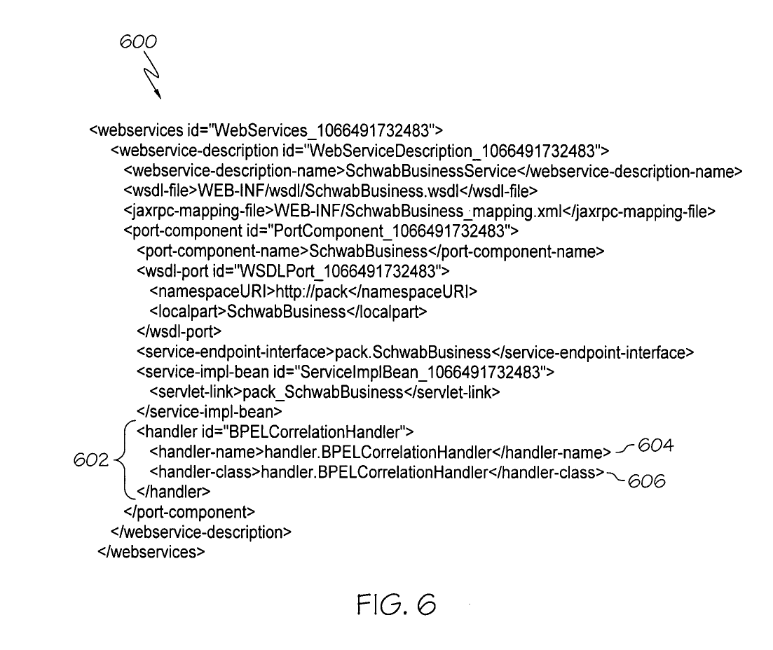

When deploying Web services agent 506, the Web services handler may be defined in a Web service deployment descriptor. Turning now to FIG. 6, a diagram illustrating an exemplary Web service deployment descriptor is depicted in accordance with an illustrative embodiment of the present invention. As shown in FIG. 6, Web services deployment descriptor 600 includes a handler element, which defines the name and the class of the Web services handler. In this example, the handler name is “BPELCorrelationHandler” 602, with handler-name 604 handler.BPELCorrelationHandler” and a handler-class 606 handler.BPELCorrelationHandler”.

While the enterprise JavaBeans software program specification does not support filters or agents, the specific EJB container implementation do. Thus, EJB filter agent 508 may be deployed by using an EJB callback mechanism that registers a particular generic method with the programming model extensions. The callback mechanism calls back a registered method upon invocation of a specific EJB method in order to report information to central business workflow language generator 502.

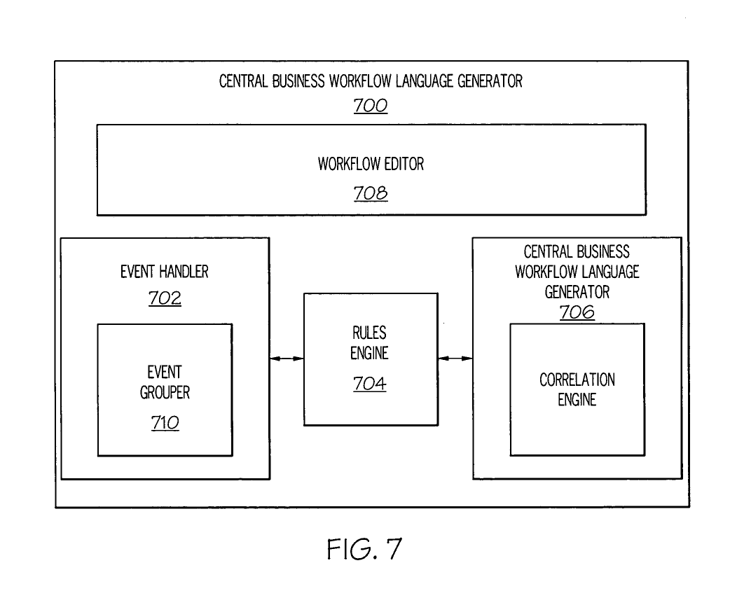

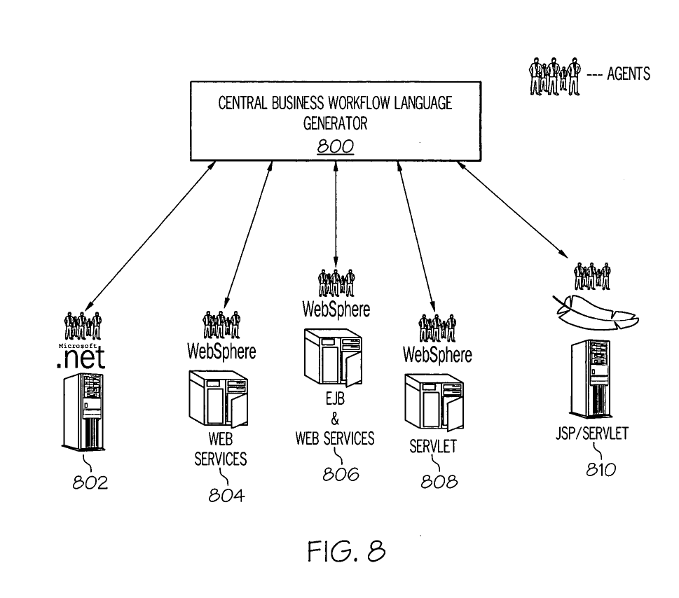

Turning now to FIG. 7, a diagram illustrating an exemplary business workflow language generator is depicted in accordance with an illustrative embodiment of the present invention. As shown in FIG. 7, business workflow language generator 700 includes event handler 702, rules engine 704, business workflow correlation engine 706, and workflow editor 708.

Event handler 702 collects events reported by the agents and uses event grouper 710 to group events into a single business workflow language activity. Once the events are grouped, business workflow correlation engine 706 performs a correlation of the business workflow activities to business workflow language constructs based on rules that are defined in rules engine 704. As described above, correlation rules are defined for the business workflow language.

The engine includes a temporal condition handler that handles the activities that are in sequence, in parallel, or repetitive. The engine also includes a collection count handler that counts the number of times a particular activity is handled. After the engine correlates business workflow activities to business workflow language constructs, workflow editor 708 presents the generated workflow to the user.

Turning now to FIG. 8, a diagram illustrating exemplary infrastructures with the business workflow language generator is depicted in accordance with an illustrative embodiment of the present invention. As depicted in FIG. 8, events of NET platform 802, Web services applications 804, EJB applications 806, Servlet 808, and JSP 810 may be collected by deployed agents and reported to business workflow language generator 800.

Business workflow language generator 800 in turn groups the events into business activities, correlates the activities to business workflow language constructs, and presents them to the user. In this way, a transparent service-oriented workflow may be developed and used across multiple platforms. In addition, automatic maintenance of the business processes may be achieved as events collected from various platforms are updated.

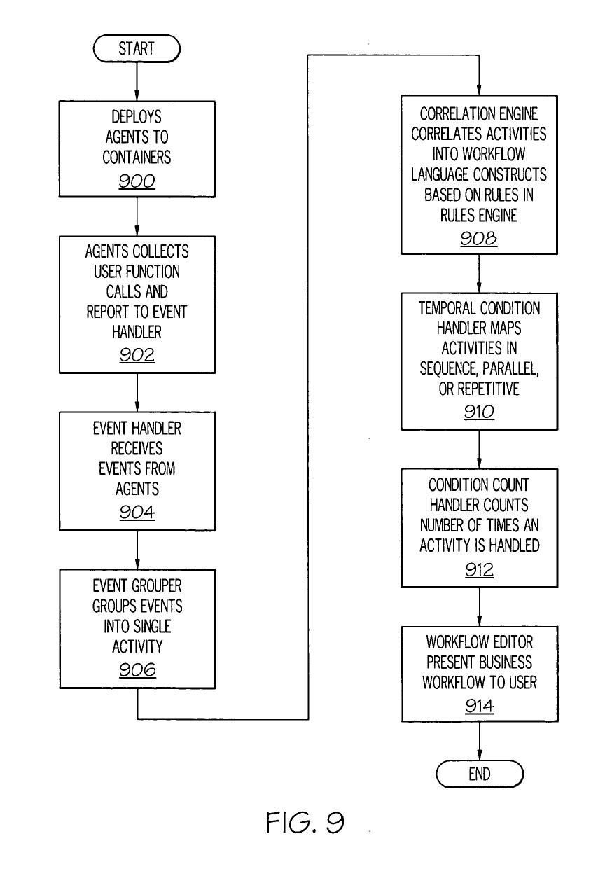

Turning now to FIG. 9, a flowchart of an exemplary process for automatic discovery and maintenance of business processes in Web services and enterprise development environments is depicted in accordance with an illustrative embodiment of the present invention. As depicted in FIG. 9, the process begins when the mechanism of the present invention deploys agents to containers (step 900), for example, Java servlet container, EJB container, .NET container, etc.

Next, agents collect a list of function calls made by the user for a period of time in the containers and reports them to the event handler (step 902). Once the event handler receives events from the agents (step 904), the event grouper classifies or group events into a single activity (step 906). A correlation engine then correlates the activities into workflow language constructs based on rules that are in the rules engine (step 908).

The temporal condition handler maps activities that are in sequence, parallel, or are repetitive (step 910). The condition count handler counts the number of times an activity is handled (step 912). Once the business workflow activities are mapped to business workflow language constructs, the workflow editor presents the workflow generated by the business workflow language generator (step 914) and the process terminates thereafter.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for automatic discovery and maintenance of business processes in web services and enterprise development environments, the method comprising:
deploying a set of agents to a set of enterprise containers;
grouping events into a single business activity in response to detecting events reported by an agent in the set of agents;
correlating activities into business workflow language constructs based on a set of rules in a rules engine;
generating a business workflow based on the business workflow language constructs; and
presenting the business workflow in a user interface, wherein the business workflow dynamically adapts to the rules defined in the rules engine.

2. The method of claim 1, wherein each agent in the set of agents collects user function calls and reports events generated in each enterprise container in the set of enterprise containers to an event handler.

3. The method of claim 1, wherein the events are detected by an event handler, wherein grouping events into a single business activity is performed by an event grouper, and wherein correlating activities into business workflow language constructs based on a set of rules in a rules engine is performed by an event correlation engine.

4. The method of claim 2, wherein correlating activities into business workflow language constructs based on a set of rules in a rules engine comprises:
mapping events that are in sequence, parallel, and repetitive into business workflow language activities using a temporal condition handler, wherein the temporal condition handler maps the activities according to a specific business workflow language, and wherein the set of rules are written according to the specific business workflow language and the events are mapped back into constructs of the specific business workflow language; and
counting a number of times an event is handled using a collection counting handler.

5. The method of claim 4, wherein the specific business workflow language comprises a business process language execution language, and wherein the set of rules defined for the business process execution language comprises:
a sequence rule for services that are called sequentially;
a flow rule for activities that are invoked in parallel and executed randomly during application runtime;
a switch rule for a service execution based on whether a condition of context of the message is met;
a while rule for repetition of a particular activity more than once; and
a Wait for a certain period of time, duration or a date.

6. The method of claim 5, wherein the set of rules further comprise:
a receive rule for a message that reaches an enterprise bean, a platform independent service, or a Web service;
a reply rule for a reply exists of a function call made to an enterprise bean, a platform independent serice, or a Web service;
an invoke rule for an enterprise bean, a platform independent service, or a Web service that calls a method asynchronously to place a message into a queue;
a Pick rule for a message that is invoked after waiting for a certain period of time from outside a network;
a stop rule for a fault message that occurs inside an enterprise bean, a platform independent service, or a Web service handler resulting in termination of the business workflow;
a compensation rule that allows a user to call a compensation logic when a fault occurs; and
a staff activity rule for a user that is involved in a staff activity detected by a correlation pattern with wait patterns and message formats.

7. The method of claim 1, wherein generating a business workflow based on the business workflow language constructs is performed by a business workflow language generator and wherein presenting the business workflow in a user interface is performed by a workflow editor.

8. The method of claim 1, wherein the set of agents comprises a servlet agent, an enterprise bean filter agent, and a Web Services agent.

9. The method of claim 8, wherein the servlet agent is deployed to a servlet engine using a filter, wherein the filter dynamically intercepts requests and responses to forward information contained in the requests or responses to a business workflow language generator.

10. The method of claim 8, wherein the Web services agent is deployed to a Web services engine using a Web services handler, wherein the Web services handler is defined in a deployment descriptor.

11. The method of claim 8, wherein the enterprise bean filter agent is deployed to an enterprise bean container, using an enterprise bean callback mechanism that registers a particular generic method with programming model extensions, and wherein the callback mechanism calls back a registered method upon invocation of a specific enterprise bean method in order to report information to a business workflow language generator.

12. A data processing system comprising:
a processor;
a memory connected to the processor via a processor bus, wherein the processor is adapted to execute computer implemented instructions in the memory to:
deploy a set of agents to a set of enterprise containers;
group events into a single business activity responsive to detecting events reported by an agent in the set of agents;
correlate activities into business workflow language constructs based on a set of rules in a rules engine;
generate a business workflow based on the business workflow language constructs; and
present the business workflow in a user interface.

13. The data processing system of claim 12, wherein the processor is further adapted to execute computer implemented instructions in the memory to:
correlate activities into business workflow language constructions based on a set of rules in a rules engine, maps events that are in sequence, parallel, and repetitive into business workflow language activities using a temporal condition handler, wherein the temporal condition handler maps the activities according to a specific business workflow language, and wherein the set of rules are written according to the specific business workflow language and the events are mapped back into constructs of the specific business workflow language; and
count a number of times an event is handled using a collection counting handler

14. The data processing system of claim 12, wherein each agent in the set of agents collects user function calls and reports events generated in each enterprise container in the set of enterprise containers to an event handler.

15. The data processing system of claim 12, wherein the set of agents comprises a servlet agent, an enterprise bean filter agent, and a Web Services agent.

16. The data processing system of claim 12, wherein generating a business workflow based on the business workflow language constructs is performed by a business workflow language generator and wherein presenting the business workflow in a user interface is performed by a workflow editor.

17. A computer program product for automatic discovery and maintenance of business processes in web services and enterprise development environments, implementing authorization policies for web services, the computer program product comprising:
a computer readable medium having computer readable program code embodied therein, the computer readable medium comprising:
computer readable program code configured to deploy a set of agents to a set of enterprise containers;
computer readable program code configured to group events into a single business activity responsive to detecting events reported by an agent in the set of agents;
computer readable program code configured to correlate activities into business workflow language constructs based on a set of rules in a rules engine;
computer readable program code configured to generate a business workflow based on the business workflow language constructs; and
computer readable program code configured to present the business workflow in a user interface.

18. The computer program product of claim 17, wherein the computer readable program code configured to correlate activities into business workflow language constructs based on a set of rules in a rules engine comprises:
computer readable program code configured to map events that are in sequence, parallel, and repetitive into business workflow language activities using a temporal condition handler, wherein the temporal condition handler maps the activities according to a specific business workflow language; and
computer readable program code configured to count a number of times an event is handled using a collection counting handler.

19. The computer program product of claim 17, wherein each agent in the set of agents collects user function calls and reports events generated in each enterprise container in the set of enterprise containers to an event handler.

20. The computer program product of claim 17, wherein the set of agents comprises a servlet agent, an enterprise bean filter agent, and a Web Services agent.
